(19) United States
(12) Patent Application Publication
(10) Pub. No.: US 2015/0279259 A1
(43) Pub. Date: Oct. 1, 2015

(54) LIQUID CRYSTAL DISPLAY DEVICE

(71) Applicant: SAMSUNG DISPLAY CO., LTD., Yongin-City (KR)

(72) Inventors: Dae-Gwang Jang, Cheonan-si (KR); Seokha Hong, Yongin-si (KR); Byungsun Kim, Seoul (KR); Sangik Lee, Seoul (KR)

(21) Appl. No.: 14/541,022

(22) Filed: Nov. 13, 2014

(30) Foreign Application Priority Data
Mar. 27, 2014 (KR) 10-2014-0035967

(51) Int. Cl. G09G 3/18

(52) U.S. Cl. CPC G09G 3/18; G09G 2310/08

(57) ABSTRACT

According to some embodiments of the present invention, there is provided a liquid crystal display device including a display panel configured to receive a plurality of gate signals and a plurality of data voltages and to display an image based on a plurality of frames, a timing controller configured to generate a data control signal and a plurality of vertical start signals corresponding to the frames, a gate driving unit configured to output a plurality of gate signals in response to a vertical start signal according to each frame, and a data driving unit configured to generate the data voltages in response to the data control signal, wherein the timing controller is configured to set activation times of the vertical start signals corresponding to the frames differently to allow the frames to have different frequencies.

### CROSS-REFERENCE TO RELATED APPLICATION

This application claims priority to and the benefit of Korean Patent Application No. 10-2014-0035967, filed on Mar. 27, 2014, the entire content of which is hereby incorporated by reference.

### BACKGROUND

1. Field

The present invention relates to a display device, and more particularly, to a time-division driving based liquid crystal display device.

2. Description of the Related Art

A liquid crystal display device is currently one of the most widely used flat panel display devices. The liquid crystal display device includes two substrates where an electric field generating electrode such as a pixel electrode and a common electrode are formed and a liquid crystal layer inserted therebetween. An alignment of liquid crystal molecules in the liquid crystal layer may be determined in response to a voltage difference between the pixel electrode and the common electrode. The liquid crystal display device may display an image by controlling the polarization of an incident light penetrating from the outside to the liquid crystal layer.

Especially, because a vertical alignment (VA) mode based liquid crystal display device implements a large contrast ratio and a wide reference viewing angle easily, it receives great attentions. Here, the reference viewing angle refers to a viewing angle of which contrast ratio is 1:10 or a brightness inversion limit angle between gradation levels.

In relation to the VA mode based liquid crystal display device, there are methods of forming an incision part on an electric field generating electrode and methods of forming a protrusion on an electric field generating electrode, in order to realize a wide viewing angle. The reference viewing angle widens by distributing the tilt directions of liquid crystal molecules into several different directions by using the incision part or the protrusion.

However, the VA mode based liquid crystal display device has a side visibility that is less than a front visibility. For example, in the case of a patterned vertically aligned (PVA) liquid crystal display device including an incision part, as one gradually approaches the side of the display (i.e., as the angle of view, with respect to the direction normal to the display, increases), a brightness difference between high gradation levels is substantially reduced (e.g., disappears). Therefore, an image at this side may not be clearly seen (e.g., may be seen vaguely).

### SUMMARY

Aspects of embodiments of the present invention are directed toward a liquid crystal display device having improved visibility.

According to some embodiments of the present invention, there is provided a liquid crystal display device including: a display panel configured to receive a plurality of gate signals and a plurality of data voltages and to display an image based on a plurality of frames; a timing controller configured to generate a data control signal and a plurality of vertical start signals corresponding to the frames; a gate driving unit configured to output a plurality of gate signals in response to a vertical start signal according to each frame; and a data driving unit configured to generate the data voltages in response to the data control signal, wherein the timing controller is configured to set activation times of the vertical start signals corresponding to the frames differently to allow the frames to have different frequencies.

In one embodiment, the plurality of frames includes a first sub frame and a second sub frame.

In one embodiment, the display panel includes a plurality of pixels configured to display the image by receiving the data voltages in response to the gate signals, and wherein the pixels are further configured to display one image in response to the first sub frame and the second sub frame.

In one embodiment, the data driving unit is configured to output data voltages corresponding to the first sub frame to the pixels and to output data voltages corresponding to the second sub frame to the pixels.

In one embodiment, gradation levels of the data voltages corresponding to the first sub frame are set higher than those of the data voltages corresponding to the second sub frame.

In one embodiment, an activation interval of a vertical start signal corresponding to the second sub frame is set longer than that of a vertical start signal corresponding to the first sub frame.

In one embodiment, an activation interval of gate signals outputted in response to a vertical start signal of the second sub frame is set longer than that of gate signals outputted in response to a vertical start signal of the first sub frame.

According to some embodiments of the present invention, there is provided a liquid crystal display device including: a display panel configured to receive a plurality of gate signals and a plurality of data voltages and to display an image based on a plurality of frames; a timing controller configured to generate a data control signal and a plurality of vertical start signals corresponding to the plurality of frames; a gate driving unit configured to output a plurality of gate signals in response to a vertical start signal according to each frame; a data driving unit configured to generate the data voltages in response to the data control signal; and a backlight unit configured to supply light to the display panel, wherein the timing controller is configured to set activation times of the vertical start signals corresponding to the frames differently to allow the frames to have different frequencies and the backlight unit is configured to supply light with different periods for each of the frames.

In one embodiment, the timing controller is further configured to generate a backlight control signal, wherein the backlight unit is configured to supply light with different periods for different ones of the frames in response to the backlight control signal.

In one embodiment, the plurality of frames include a first sub frame and a second sub frame.

In one embodiment, the display panel includes a plurality of pixels configured to display the image by receiving the data voltages in response to the gate signals, wherein the pixels are further configured to display one image in response to the first sub frame and the second sub frame.

In one embodiment, the data driving unit is configured to output data voltages corresponding to the first sub frame to the pixels and to output data voltages corresponding to the second sub frame to the pixels.

In one embodiment, the liquid crystal display device further includes a gradation control unit configured to adjust gradation level values of the data voltages corresponding to the first sub frames and the data voltages corresponding to the second sub frames based on a light period outputted from the backlight unit.

In one embodiment, gradation levels of the data voltages corresponding to the first sub frame are set higher than those of the data voltages corresponding to the second sub frame.

In one embodiment, wherein the backlight unit is configured to supply light continuously during the first sub frame and to supply light for a time period during the second sub frame.

In one embodiment, the backlight unit is configured to supply light for a time period during the first sub frame and the second sub frame.

In one embodiment, an activation interval of a vertical start signal corresponding to the second sub frame is set longer than that of a vertical start signal corresponding to the first sub frame.

In one embodiment, an activation interval of gate signals outputted in response to a vertical start signal of the second sub frame is set longer than that of gate signals outputted in response to a vertical start signal of the first sub frame.

### BRIEF DESCRIPTION OF THE DRAWINGS

The accompanying drawings are included to provide a further understanding of the present invention, and are incorporated in and constitute a part of this specification. The drawings illustrate example embodiments of the present invention and, together with the description, serve to explain principles of the present invention. In the drawings:

FIG. 1 is a block diagram illustrating a liquid crystal display device, according to an example embodiment of the present invention;

FIG. 2 is a circuit diagram of a pixel located in the display panel shown in

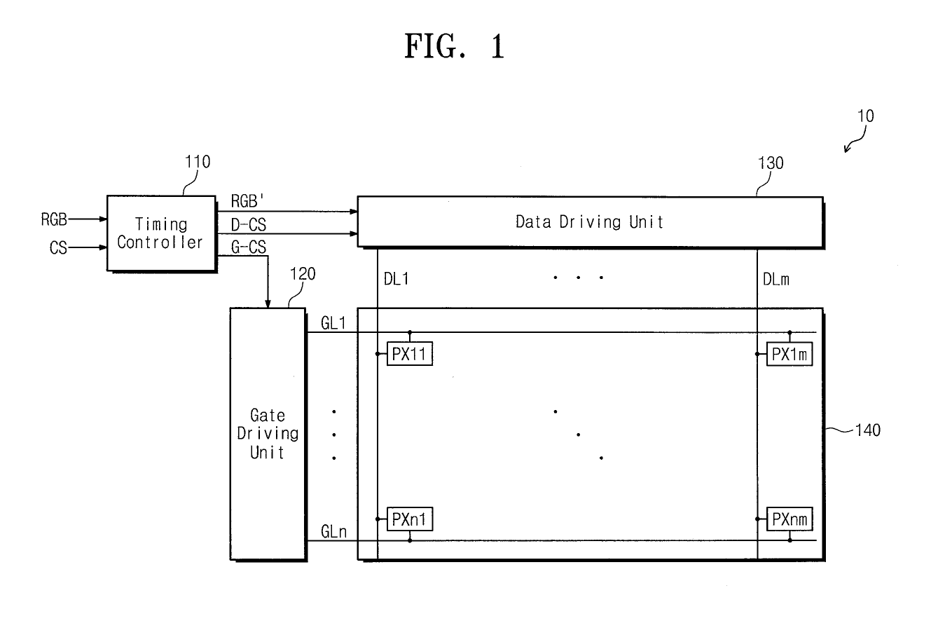

FIG. 1, according to an example embodiment of the present invention;

FIG. 3 is a graph illustrating a conventional response characteristic of liquid crystal molecules based on time-division driving;

FIG. 4 is a timing diagram illustrating an operation of a time-division driving based gate driving unit, according to an example embodiment of the present invention;

FIG. 5 is a graph illustrating a response characteristic of a liquid crystal molecule on the basis of an operation of the gate driving unit of FIG. 3, according to an example embodiment of the present invention;

FIG. 6 is a block diagram illustrating a liquid crystal display device, according to another example embodiment of the present invention;

FIG. 7 is a timing diagram illustrating an operation of a time-division driving based gate driving unit and backlight unit, according to an example embodiment of the present invention; and

FIG. 8 is a timing diagram illustrating an operation of a time-division driving based gate driving unit and backlight unit, according to another example embodiment of the present invention.

### DETAILED DESCRIPTION

The present invention has various modifications and forms, and thus specific embodiments are shown in the drawings and related details are described. However, this does not limit specific disclosure forms and should be understood that all modifications, equivalents, and alternatives of the specific embodiments are within the spirit and scope of the present invention.

In describing each drawing, like reference numerals refer to like elements. For purpose of clarity, in the accompanying drawings, the dimensions of structures shown may be exaggerated, as compared to the actual dimensions. It will be understood that the terms “first” and “second” are used herein to describe various components but these components should not be limited by these terms. These terms are used only to distinguish one component from other components. For example, a first component may be referred to as a second component and vice versa without departing from the scope of the present invention. The terms of a singular form may include plural forms unless they have a clearly different meaning in the context.

In this specification, it should be understood that the term “include,” “comprise,” “including,” or “comprising,” specifies a property, a number, a step, an operation, an element, a component, or a combination thereof but does not exclude one or more properties, numbers, steps, operations, elements, components, combinations, or additional possibilities.

FIG. 1 is a block diagram illustrating a liquid crystal display device, according to an example embodiment of the present invention.

Referring to FIG. 1, the liquid crystal display device 10 includes a timing controller 110, a gate driving unit 120, a data driving unit 130, and a display panel 140.

The timing controller 110 receives a plurality of image signals RGB and a plurality of control signals CS from the outside of the liquid crystal display device 10.

The timing controller 110 converts a data format of the image signals RGB to meet an interface specification with the data driving unit 130. The data format converted image signals RGB' are provided to the data driving unit 130.

Additionally, the timing controller 110 generates a data control signal D-CS and a gate control signal G-CS in response to the control signals CS. For example, the data control signal D-CS may include an output start signal and a horizontal start signal. The gate control signal G-CS may include a vertical start signal and a vertical clock bar signal. The timing controller 110 provides the data control signal D-CS to the data driving unit 130 and provides the gate control signal G-CS to the gate driving unit 120.

According to an embodiment of the present invention, the liquid crystal display device 10 outputs an image on the basis of a field sequence (i.e., the display device 10 is a sequential type). For example, unlike an existing liquid crystal display device displaying one image based on one frame, the liquid crystal display device 10 may display an image based on two frames. Moreover, although it is described that the liquid crystal display device 10 displays one image on the basis of two frames, embodiments of the present invention are not limited thereto. For example, one image may be displayed based on a plurality of frames according to a frequency setting.

The timing controller 110 may generate a gate control signal G-CS and a data control signal D-CS based on a plurality of frames according to a frequency setting.

The gate driving unit 120 outputs gate signals sequentially in response to the gate control signal G-CS provided by the timing controller 110. A plurality of pixels PX11 to PXnm in the display panel 140 may be sequentially scanned by a row unit in response to gate signals.

The data driving unit 130 converts the data format converted image signals RGB' into a plurality of data voltages in response to the data control signal D-CS provided by the timing controller 110. The data driving unit 130 outputs the data voltages to the display panel 140.

The display panel 140 includes a plurality of gate lines GL1 to GLn, a plurality of data lines DL1 to DLm, and a plurality of pixels PX11 to PXnm.

The gate lines GL1 to GLn extend in a row direction and are arranged to cross the extended data lines DL1 to DLm. The gate lines GL1 to GLn are electrically coupled to (e.g., electrically connected to) the gate driving unit 120 and receive a plurality of gate signals. The data lines DL1 to DLm are electrically coupled to the data driving unit 130 and receive a plurality of data voltages. Each of the pixels PX11 to PXnm is coupled to (e.g., connected to) the corresponding gate line GL and the corresponding data line DL.

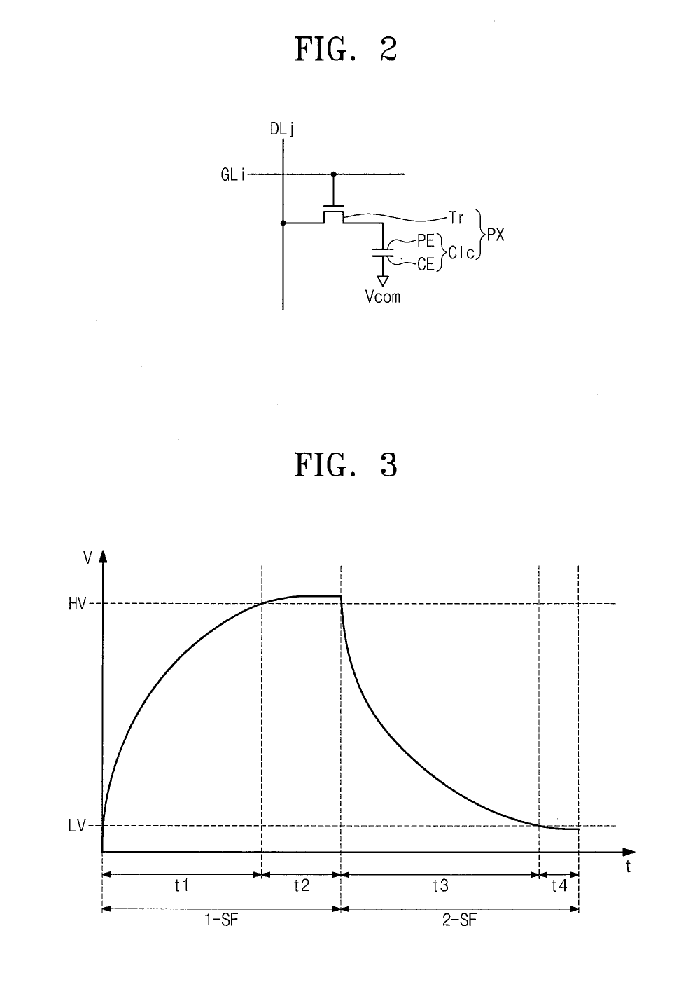

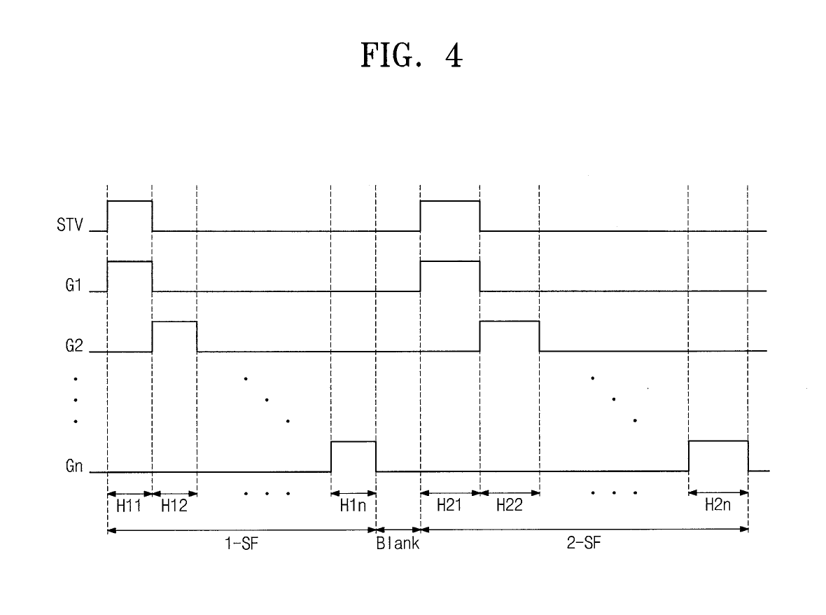

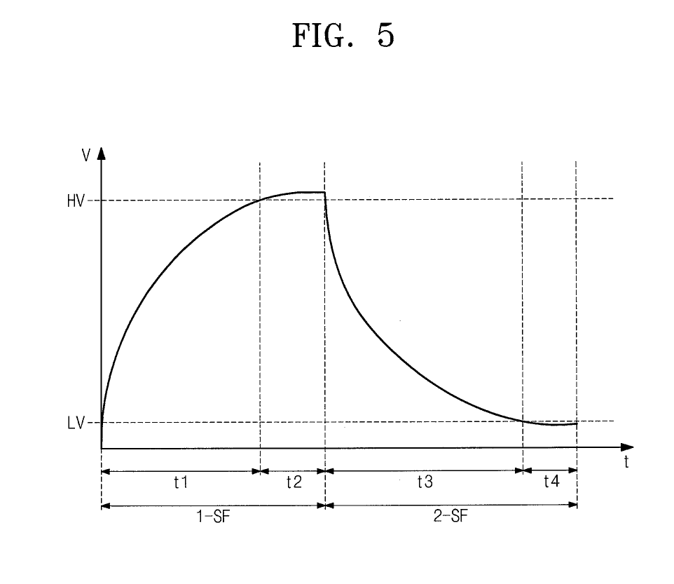

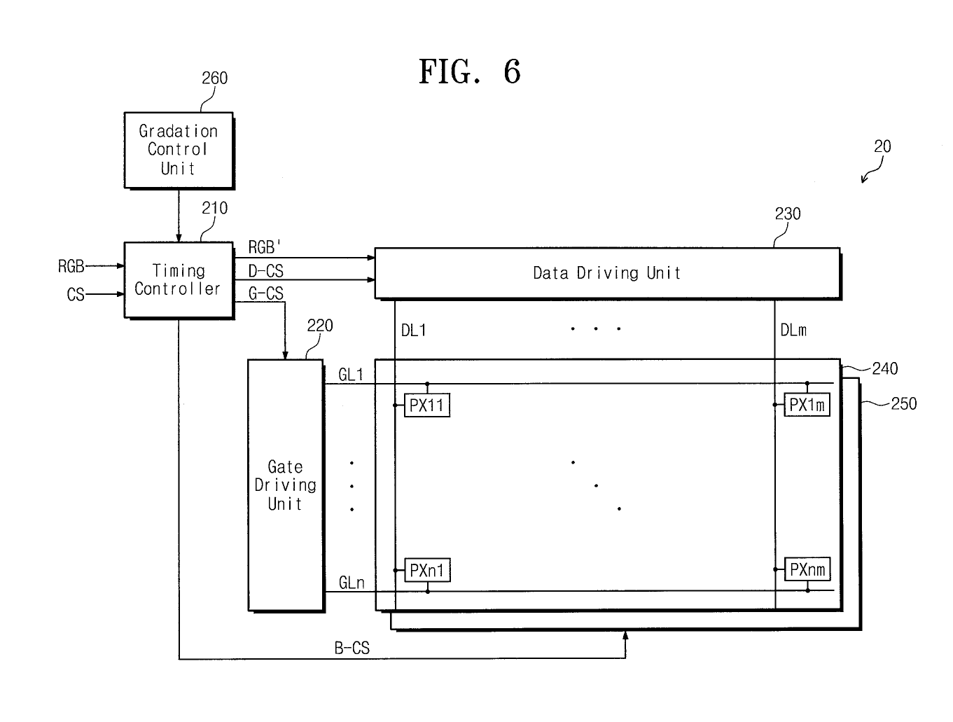

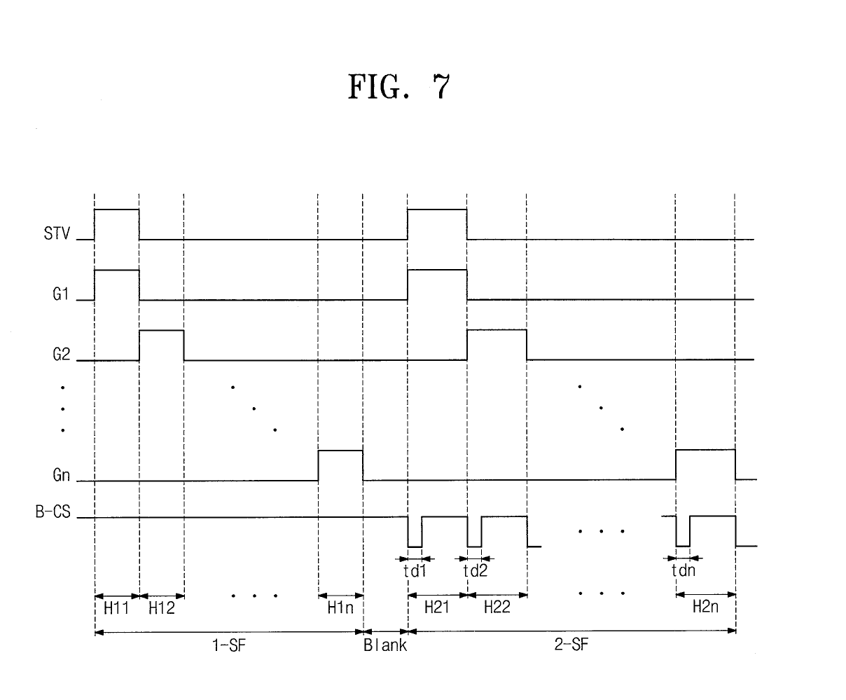

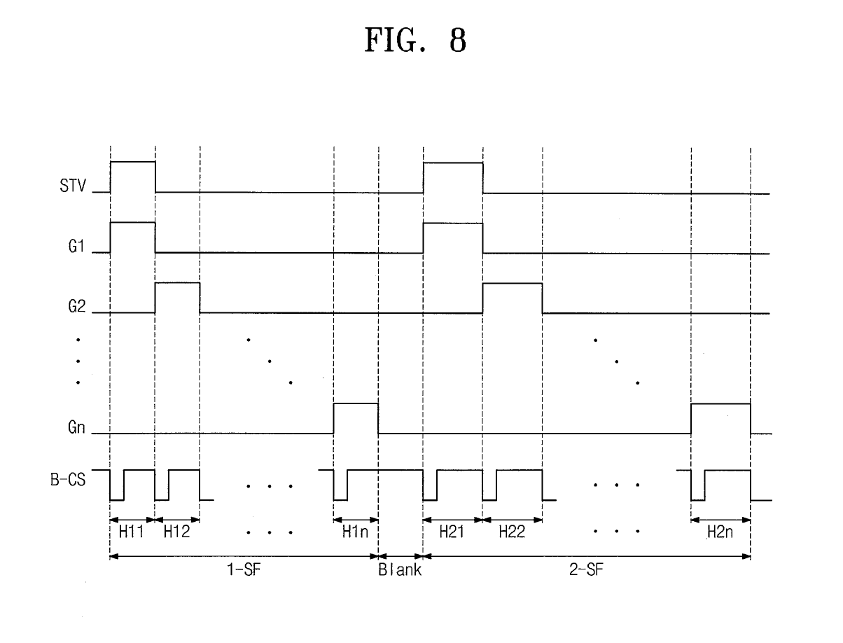

FIG. 2 is a circuit diagram of a pixel located in the display panel shown in FIG. 1, according to an embodiment of the present invention.

Referring to FIG. 2, one pixel PX among the pixels PX11 to PXnm of FIG. 1 located in the display panel 140 of FIG. 1 is disclosed. Additionally, one gate line GLi among the plurality of gate lines GL1 to GLn and one data line DLj among the plurality of data lines DL1 to DLm are each coupled to the pixel PX, as shown. Here, n and m are integers greater than 0. i is an integer greater than 0 and less than or equal to n. j is an integer greater than 0 and less than or equal to m.

The pixel PX coupled to the gate line GLi and the data line DLj includes a thin film transistor Tr and a liquid crystal capacitor Clc coupled to the thin film transistor Tr. The thin film transistor Tr includes a gate electrode coupled to the gate line GLi, a source electrode coupled to the data line DLj, and a drain electrode coupled to the liquid crystal capacitor Clc.

Additionally, the liquid crystal capacitor Clc is formed by a pixel electrode electrically coupled to the drain electrode of the thin film transistor Tr, a common electrode CE facing the pixel electrode PE, and a liquid crystal layer located between the pixel electrode PE and the common electrode CE. The liquid crystal capacitor Clc may be charged with a difference voltage between a data voltage supplied to the pixel electrode PE and a common voltage supplied to the common electrode CE.

FIG. 3 is a graph illustrating a comparable response characteristic of liquid crystal molecules based on time-division driving.

Referring to FIG. 3, a horizontal axis represents each frame t according to a frequency setting and a vertical axis represents a voltage level V of the pixel electrode PE of FIG. 2. Additionally, the graph of FIG. 3 illustrates a response characteristic of a liquid crystal molecule during first and second sub frames Frame 1 and Frame 2 on the basis of one pixel among a plurality of pixels. Here, the first and second sub frames 1-SF and 2-SF may be defined as a unit frame, that is, a time unit in which one image is provided.

In general, a liquid crystal display device has a side visibility that is less than a front visibility based on the liquid crystal characteristics. In order to improve (e.g., increase) such a side visibility, a liquid crystal display device may operate based on a time-division driving method. To achieve such a time-division driving, a liquid crystal display device may display an image of a desired gradation level based on the first and second sub frames 1-SF and 2-SF. For example, an image of a desired gradation level may be displayed based on an average of a gradation level corresponding to a data voltage of the first sub frame 1-SF and a gradation level corresponding to a data voltage of the second sub frame 2-SF. In one example, the frequency (e.g., refresh rate) of each of the first and second sub frames 1-SF and 2-SF may be set to about 120 Hz but is not limited thereto.

Additionally, a gradation level corresponding to a data voltage of the first sub frame 1-SF may be greater than a gradation level corresponding to a data voltage of the second sub frame 2-SF. For example, in order to display 150 gray levels during the first and second sub frames, a data voltage corresponding to 250 gray levels during the first sub frame 1-SF may be set and a data voltage corresponding to 50 gray levels during the second sub frame 2-SF may be set. Additionally, in the following description of the present invention, it is described that a data voltage of the first sub frame 1-SF is greater than a data voltage of the second sub frame 2-SF. However, embodiments of the present invention are not limited thereto.

Referring to FIG. 3, the first sub frame 1-SF includes first and second times t1 and t2.

During the first time period t1, an electric field is generated between the pixel electrode PE and the common electrode CE (see FIG. 2) by a data voltage applied to the pixel electrode PE and a common voltage applied to the common electrode CE. A liquid crystal molecule of a liquid crystal layer is rearranged by an electric field generated between the pixel electrode PE and the common electrode CE. That is, the first time period t1 is an interval during which orientation of a liquid crystal module (e.g., liquid crystal or liquid crystal structure) of a liquid crystal layer changes, when a voltage level of the pixel electrode PE has not yet reached a data voltage level corresponding to a desired gradation level. Here, a data voltage level corresponding to a desired gradation level of the first sub frame 1-SF may be a high voltage level HV.

That is, the second time period t2 is an interval during which an image corresponding to a desired gradation level is displayed, when a voltage level of the pixel electrode PE reaches a data voltage level of a desired gradation level, that is, a high voltage level HV.

The second sub frame 2-SF includes third and fourth time periods t3 and t4.

During the third time period t3, an electric field is generated between the pixel electrode PE and the common electrode CE by a data voltage applied to the pixel electrode PE and a common voltage applied to the common electrode CE. A liquid crystal molecule of a liquid crystal layer is rearranged by an electric field generated between the pixel electrode PE and the common electrode CE. That is, the third time period t3 is an interval during which orientation of a liquid crystal module (e.g., liquid crystal or liquid crystal structure) of a liquid crystal layer changes, when a voltage level of the pixel electrode PE has not yet reached a data voltage level corresponding to a desired gradation level. Here, a data voltage level corresponding to a desired gradation level of the second sub frame 2-SF may be a low voltage level LV.

The fourth time period t4 is an interval during which an image corresponding to a desired gradation level is displayed, when a voltage level of the pixel electrode PE reaches a data voltage level of a desired gradation level, that is, a low voltage level LV.

As described above, an image of a desired gradation level may be displayed during the second and fourth time periods t2 and t4. However, in general, a response characteristic of a liquid crystal module may have a lower response speed during an interval for reaching a low voltage level, not an interval for reaching a high voltage level. Therefore, the fourth time period t4 may be shorter than the second time period t2. As a result, wash-out effects (e.g., wash-out defects) may occur as the lights from adjacent pixels mix together.

According to an embodiment of the present invention, the liquid crystal display device 10 may differently set the frequencies of the first and second sub frames 1-SF and 2-SF. For example, in order to increase the interval of the fourth time period t4 during which a low level voltage is reached, a frequency of the second sub frame 2-SF may be longer than that of the first sub frame 1-SF. Such an operation is described below in more detail.

FIG. 4 is a timing diagram illustrating an operation of a time-division driving based gate driving unit, according to an example embodiment of the present invention.

Referring to FIGS. 1 and 4, the timing controller 110 provides the gate control signal G-CS to the gate driving unit 120. The gate control signal G-CS may include a vertical start signal STV controlling operations of gate signals outputted from the gate driving unit 120. The gate driving unit 120 may sequentially output a plurality of gate signals according to each frame in response to the vertical start signal SW.

Moreover, according to an embodiment of the present invention, the timing controller 110 may control the vertical start signal STV so as to differently set the frequencies of the first and second sub frames 1-SF and 2-SF. As described with reference to FIG. 3, the first and second sub frames 1-SF and 2-SF may be defined as a unit frame, that is, a time unit in which one image is provided. Additionally, in the description of the present invention, a gradation level of data voltages corresponding to the first sub frame 1-SF may be set higher than that of data voltages corresponding to the second sub frame 2-SF.

First, during the first sub frame 1-SF, in response to the vertical start signal STV by from the timing controller 110, the gate driving unit 120 provides a first gate signal G1 to a first gate line GL1 during a first activation interval H11. The first pixel PX11 delivers a corresponding first data voltage to the pixel electrode PE of FIG. 2 in response to the first gate signal G1. Here, the first data voltage may be in the high voltage level described with reference to FIG. 3.

Additionally, although it is described that the vertical start signal SW and the first gate signal G1 reach (e.g., changes to or shift into) a high level concurrently (e.g., simultaneously), embodiments of the present invention are not limited thereto. For example, the vertical start signal STV may change to a high level during an interval before the first gate signal G1 is activated.

Then, as the first gate signal G1 changes to a low level, the gate driving unit 120 outputs a second gate signal G2 to a second gate line during a second activation interval H12. That is, as the first gate signal G1 changes to a low level, the second gate signal G2 (the next gate signal) may change to a high level.

As the above-mentioned operations are repeated, during the first sub frame 1-SF, in response to the vertical start signal SW, first to nth gate signals G1 to Gn may be outputted sequentially.

Moreover, after the first to nth gate signals G1 to Gn according to the first sub frame 1-SF are outputted, there may be a blank before the second sub frame 2-SF, that is, the next frame, is outputted. According to an embodiment of the present invention, the timing controller 110 may increase the second sub frame 2-SF by recuing such a blank. Herein, the blank shown in FIG. 4 may be a blank that is reduced by a time (e.g., a predetermined time) in comparison to an existing blank.

In one embodiment, the timing controller 110 may further increase the frequency of the second sub frame 2-SF by the time (e.g., the predetermined time) in comparison to the frequency of the first sub frame 1-SF, on the basis of the blank that is reduced by the time (e.g., the predetermined time). That is, the vertical start signal SW of the second sub frame 2-SF may be activated faster by the time (e.g., the predetermined time). As a result, an interval during which the first to nth gate signals G1 to Gn are activated according to the second sub frame 2-SF may be increased more than an existing interval.

During the second sub frame 2-SF, in response to the vertical start signal SW provided by the timing controller 110, the gate driving unit 120 provides the first gate signal G1 to the first gate line GL1 during a first activation interval H21. The first pixel PX11 delivers a corresponding first data voltage to the pixel electrode PE of FIG. 2 in response to the first gate signal G1 according to the second sub frame 2-SF. Here, the first data voltage may be in the low voltage level described with reference to FIG. 2.

As mentioned above, as the frequency of the second sub frame 2-SF is set longer than that of the first sub frame 1-SF, the first activation interval H21 of the first gate signal G1 in the second sub frame 2-SF may be increased. As a result, the fourth time period t4 for reaching the low voltage level of FIG. 3 may be increased.

FIG. 5 is a graph illustrating a response characteristic of a liquid crystal molecule on the basis of an operation of the gate driving unit of FIG. 4, according to an embodiment of the present invention.

Referring to FIG. 5, the horizontal axis represents time according to a frequency setting and the vertical axis represents a voltage level of a pixel electrode. Additionally, similar to the graph of FIG. 3, the graph of FIG. 5 illustrates a response characteristic of a liquid crystal molecule during first and second sub frames Frame 1 and Frame 2 on the basis of one pixel among a plurality of pixels.

As shown in FIG. 5, the frequencies of the first and second sub frames 1-SF and 2-SF may be set differently. In one embodiment, the fourth time period t4 of the second sub frame 2-SF is increased in correspondence to the blank of FIG. 3 reduced by the time (e.g., the predetermined time). As the fourth time period t4 is increased by the time (e.g., the predetermined time), a low voltage level interval may be increased.

As mentioned above, as the low voltage level interval is increased, an average gradation level between the first and second sub frames 1-SF and 2-SF may be outputted as normal gradation level. As a result, the overall visibility of the liquid crystal display device 10 of FIG. 1 may be improved (e.g., increased). Therefore, on the basis of the above-mentioned frequency setting, the side visibility of the liquid crystal display 10 may be improved (e.g., increased) efficiently.

FIG. 6 is a block diagram illustrating a liquid crystal display device, according to another example embodiment of the present invention.

Referring to FIG. 6, the liquid crystal display device 20 includes a timing controller 210, a gate driving unit 220, a data driving unit 230, a display panel 240, a backlight unit 250, and a gradation control unit 260. As compared to the liquid crystal display device 10, the liquid crystal display device 20 additionally includes the backlight unit 250 and the gradation control unit 260 and operations of the remaining components other than the timing controller 210 may be substantially identical (e.g., identical). Therefore, descriptions for the operations of the remaining components may not be repeated.

First, similar to the liquid crystal display device 10 described with reference to FIG. 1, the liquid crystal display device 20 may output an image on the basis of a field sequence (i.e., the display device 10 is a sequential type). That is, the liquid crystal display device 20 may display one image on the basis of two frames. Moreover, although it is described that the liquid crystal display device 20 displays one image on the basis of two frames, embodiments of the present invention are not limited thereto. That is, one image may be displayed based on a plurality of frames according to a frequency setting.

In more detail, a plurality of pixels PX11 to PXnm located in the display panel 240 may display one image according to an average gradation level between first and second sub frames 1-SF and 2-SF of FIG. 7. That is, the pixels PX11 to PXnm may display one image on the basis of the first and second sub frames 1-SF and 2-SF. Moreover, the frequencies of the first and second sub frames 1-SF and 2-SF may be set differently. For example, as a blank time between the first and second sub frames 1-SF and 2-SF is reduced, the frequency of the second sub frame 2-SF may be further increased than that of the first sub frame 1-SF. Because this is substantially identical (e.g., identical) to the operating method described with reference to FIG. 4, its description may not be repeated.

The timing controller 210 generates a data control signal D-CS, a gate control signal G-CS, and a backlight control signal B-CS in response to the control signals CS. The timing controller 210 provides a data control signal D-CS to the data driving unit 230, provides a gate control signal G-CS to the gate driving unit 220, and provides a backlight control signal B-CS to the backlight unit 250.

The backlight unit 250 is located at the rear of the display panel 240 and supplies light to the display panel. Especially, the backlight unit 250 may supply light to the display panel 240 in response to the backlight control signal B-CS provided by the timing controller 210.

According to an embodiment of the present invention, in response to the backlight control signal B-CS, the backlight unit 250 may supply light continuously during the first sub frame 1-SF and may supply light periodically during the second sub frame 2-SF.

According to an embodiment of the present invention, in response to the backlight control signal B-CS, the backlight unit 250 may periodically supply light to each of the first and second sub frames 1-SF and 2-SF. Supplying light periodically by the backlight unit 250 will be described in more detail with reference to FIG. 7.

The gradation control unit 260 may receive gradation level values of the pixels PX11 to PXnm corresponding to each frame from the display panel 240 on the basis of operations of the backlight unit 250. For example, the gradation control unit 260 may measure gradation level values of the pixels PX11 to PXnm corresponding to the first and second sub frames 1-SF and 2-SF in advance.

The gradation control unit 260 may set gradation level values of the pixels PX11 to PXnm corresponding to the first and second sub frames 1-SF and 2-SF on the basis of the measured gradation level values. The gradation control unit 260 delivers the gradation level values of the set pixels PX11 to PXnm to the timing controller 210. The timing controller 210 sets a data control signal D-CS to be provided to the data driving unit in response to the gradation level value delivered from the gradation control unit 260. Then, the data driving unit 230 sets data voltages to be provided to the pixels PX11 to PXnm according to the first and second sub frames 1-SF and 2-SF, in response to the data control signal D-CS set by the timing controller 210.

FIG. 7 is a timing diagram illustrating an operation of a time-division driving based gate driving unit and backlight unit, according to an example embodiment of the present invention.

In the description of the present invention, an operation of the gate driving unit shown in FIG. 7 may be substantially identical (e.g., identical) to that of the gate driving unit shown in FIG. 4. Therefore, description for this may not be repeated.

Referring to FIGS. 6 and 7, during the first sub 1-SF, the backlight unit 250 supplies light to the display panel 240 continuously in response to the backlight control signal B-CS. For example, the backlight unit 250 maintains a turned-on state during the first sub frame 1-SF and then provides light to the display panel 240.

Moreover, during the second sub frame 2-SF, the backlight unit 250 supplies light to the display panel 240 periodically in response to the backlight control signal B-CS. For example, the backlight unit 250 may be turned on or off periodically during the second sub frame 2-SF. That is, the backlight unit 250 supplies light during a turned-on interval and does not provide light during a turned off interval.

The timing controller 210 may set the backlight control signal B-CS on the basis of a plurality of image signals RGB received from the outside.

For example, during the second sub frame 2-SF, the backlight unit 250 turns off light by a first time period td1 defined as a time (e.g., a predetermined time) from the start point of a first activation interval H21 in the first activation interval H21 of the first gate signal G1. That is, the backlight unit 250 does not supply light to the pixels PX11 to PXnm by the first time period td1 during the first activation interval H21. At this point, in comparison to the first sub frame 1-SF, the first time period td1 during which light is not supplied may be substantially identical (e.g., identical) to an extended time of the second sub frame 2-SF, but is not limited thereto. Additionally, the first time period td1 is defined as a time (e.g., a predetermined time) from the start point of the first activation interval H21 and thus may be part of an interval during which a data voltage level does not reach a low voltage level LV of FIG. 5.

As a result, the liquid crystal display device 20 may have an effect that the frequency times of the first and second sub frames 1-SF and 2-SF are set to be substantially identical (e.g., set to be identical).

However, because light is not supplied to the pixels PX11 to PXnm during the first time period td1 in the first activation interval H21 of the second sub frame 2-SF, a gradation level value corresponding to the first time period td1 may be compensated during the first activation interval H11 of the first sub frame 1-SF. For example, the pixels PX11 to PXnm may display a block image during the first time period td1 during which the backlight unit 250 is turned off.

In one embodiment, as black gradation level is displayed during the first time period td1 of the second frame 2-SF, an average brightness between the first frame 1-SF and the second frame 2-SF may be deteriorated. In order to compensate for the deteriorated brightness, a gradation level value of the first frame 1-SF may be compensated. Here, the compensated gradation level value is a value corresponding to a brightness value deteriorated according to a black gradation level. Therefore, the gradation level value of the first frame 1-SF may be increased by a gradation level value corresponding to the brightness value deteriorated by a black gradation level.

However, the gradation control unit 260 may measure a gradation level value compensated during the first activation interval H11 of the first sub frame 1-SF. The gradation control unit 260 may deliver the gradation level value compensated during the first activation interval H11 of the first sub frame 1-SF to the first sub frame 1-SF. The timing controller 210 may set a data control signal D-CS to output data voltage on the basis of the compensated gradation level value, during the first activation interval H11 of the first sub frame 1-SF.

As a result, the data driving unit 230 may output data voltage to the display panel 240 on the basis of the compensated gradation level value, during the first activation interval H11 of the first sub frame 1-SF.

Additionally, although it is described that the first time period td1 during which light is not supplied during the second sub frame 2-SF is substantially identical (e.g., identical) to an extended time of the second sub frame 2-SF, embodiments of the present invention are not limited thereto. Moreover, times at which light is not supplied to the first to nth activation intervals of the second sub frame 2-SF may be different from each other.

FIG. 8 is a timing diagram illustrating an operation of a time-division driving based gate driving unit and backlight unit, according to another example embodiment of the present invention.

Referring to FIGS. 6 and 8, in comparison to the timing diagram of FIG. 7, the remaining operations may be the same except for an interval of the first sub frame 1-SF. Therefore, descriptions for the operations of the second sub frame 2-SF may not be repeated.

In one embodiment, during the first and second sub frames 1-SF and 2-SF, the backlight unit 250 supplies light to the display panel 240 periodically in response to the backlight control signal B-CS. The backlight unit 250 may be turned on or off periodically during the first sub frame 1-SF. That is, the backlight unit 250 supplies light during a turned-on interval and does not provide light during a turned off interval.

For example, during the first sub frame 1-SF, the backlight unit 250 turns off light by a time (e.g., a predetermined time) from the start point of a first activation interval H11 in the first activation interval H11 of the first gate signal C1. That is, the backlight unit 250 does not supply light to the pixels PX11 to PXnm by a time (e.g., a predetermined time) in the first activation interval H11. Additionally, the time (e.g., the predetermined time) is defined as a time (e.g., a predetermined time) from the start point of the first activation interval H11 and thus may be part of an interval during which a data voltage level does not reach a high voltage level HV of FIG. 5.

In the same manner, during the second sub frame 2-SF, the backlight unit 250 turns off light by a time (e.g., a predetermined time) from the start point of a first activation interval H21 in the first activation interval H21 of the first gate signal G1. That is, the backlight unit 250 does not supply light to the pixels PX11 to PXnm by a time (e.g., a predetermined time) in the first activation interval H21. Additionally, the predetermined time is defined as a time (e.g., a predetermined time) from the start point of the first activation interval H21 and thus may be part of an interval during which a data voltage level does not reach a low voltage level LV of FIG. 5.

Additionally, because light is not supplied for a time (e.g., a predetermined time) in the first activation interval H11 of the first sub frame 1-SF, a gradation level value corresponding to the time (e.g., the predetermined time) may be compensated during the first activation interval H21 of the second sub frame 2-SF. In the same manner, as light is not supplied for a time (e.g., a predetermined time) in the first activation interval H21 of the second sub frame 2-SF, a gradation level value corresponding to the time (e.g., the predetermined time) may be compensated during the first activation interval H11 of the first sub frame 1-SF.

That is, during the first and second sub frames 1-SF and 2-SF, a ratio of an interval during which a data voltage level reaches a high or low voltage level may be increased. For example, as a gradation level value according to the first activation interval H11 of the first sub frame 1-SF is increased, a data voltage level may be increased. As a result, an interval during which a voltage level of the pixel electrode PE reaches a data voltage level, that is, the high voltage level HV of FIG. 5, corresponding to a corresponding gradation level, may become shorter.

As mentioned above, the backlight unit 250 adjusts light provided to the display panel 240 during the first and second sub frames 1-SF and 2-SF, so that it may improve (e.g., increased) a liquid crystal response characteristic of pixels. Accordingly, an image of a corresponding gradation level may be displayed from pixels, so that an overall visibility of a liquid crystal display device may be improved (e.g., increased).

A display device according to an embodiment of the present invention operates on the basis of time-division driving, so that the visibility of a liquid crystal display device may be improved (e.g., increased).

The above-disclosed subject matter is to be considered illustrative and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A liquid crystal display device comprising:
a display panel configured to receive a plurality of gate signals and a plurality of data voltages and to display an image based on a plurality of frames;
a timing controller configured to generate a data control signal and a plurality of vertical start signals corresponding to the frames;
a gate driving unit configured to output a plurality of gate signals in response to a vertical start signal according to each frame; and
a data driving unit configured to generate the data voltages in response to the data control signal,
wherein the timing controller is configured to set activation times of the vertical start signals corresponding to the frames differently to allow the frames to have different frequencies.

2. The device of claim 1, wherein the plurality of frames comprise a first sub frame and a second sub frame.

3. The device of claim 2, wherein the display panel comprises a plurality of pixels configured to display the image by receiving the data voltages in response to the gate signals, and wherein the pixels are further configured to display one image in response to the first sub frame and the second sub frame.

4. The device of claim 3, wherein the data driving unit is configured to output data voltages corresponding to the first sub frame to the pixels and to output data voltages corresponding to the second sub frame to the pixels.

5. The device of claim 4, wherein gradation levels of the data voltages corresponding to the first sub frame are set higher than those of the data voltages corresponding to the second sub frame.

6. The device of claim 2, wherein an activation interval of a vertical start signal corresponding to the second sub frame is set longer than that of a vertical start signal corresponding to the first sub frame.

7. The device of claim 2, wherein an activation interval of gate signals outputted in response to a vertical start signal of the second sub frame is set longer than that of gate signals outputted in response to a vertical start signal of the first sub frame.

8. A liquid crystal display device comprising:
a display panel configured to receive a plurality of gate signals and a plurality of data voltages and to display an image based on a plurality of frames;
a timing controller configured to generate a data control signal and a plurality of vertical start signals corresponding to the plurality of frames;
a gate driving unit configured to output a plurality of gate signals in response to a vertical start signal according to each frame;
a data driving unit configured to generate the data voltages in response to the data control signal; and
a backlight unit configured to supply light to the display panel,
wherein the timing controller is configured to set activation times of the vertical start signals corresponding to the frames differently to allow the frames to have different frequencies and the backlight unit is configured to supply light with different periods for each of the frames.

9. The device of claim 8, wherein the timing controller is further configured to generate a backlight control signal, wherein the backlight unit is configured to supply light with different periods for different ones of the frames in response to the backlight control signal.

10. The device of claim 8, wherein the plurality of frames comprise a first sub frame and a second sub frame.

11. The device of claim 10, wherein the display panel comprises a plurality of pixels configured to display the image by receiving the data voltages in response to the gate signals, wherein the pixels are further configured to display one image in response to the first sub frame and the second sub frame.

12. The device of claim 11, wherein the data driving unit is configured to output data voltages corresponding to the first sub frame to the pixels and to output data voltages corresponding to the second sub frame to the pixels.

13. The device of claim 12, further comprising a gradation control unit configured to adjust gradation level values of the data voltages corresponding to the first sub frames and the data voltages corresponding to the second sub frames based on a light period outputted from the backlight unit.

14. The device of claim 12, wherein gradation levels of the data voltages corresponding to the first sub frame are set higher than those of the data voltages corresponding to the second sub frame.

15. The device of claim 10, wherein the backlight unit is configured to supply light continuously during the first sub frame and to supply light for a time period during the second sub frame.

16. The device of claim 10, wherein the backlight unit is configured to supply light for a time period during the first sub frame and the second sub frame.

17. The device of claim 10, wherein an activation interval of a vertical start signal corresponding to the second sub frame is set longer than that of a vertical start signal corresponding to the first sub frame.

18. The device of claim 10, wherein an activation interval of gate signals outputted in response to a vertical start signal of the second sub frame is set longer than that of gate signals outputted in response to a vertical start signal of the first sub frame.
